(19) United States
(12) Patent Application Publication
(10) Pub. No.: US 2016/0363513 A1
(43) Pub. Date: Dec. 15, 2016

(54) Atmospheric Condensate Collector and Electrospray Source

(71) Applicant: California Institute of Technology, Pasadena, CA (US)

(72) Inventors: Fedor D. Kossakovski, Chapel Hill, NC (US); Dmitri A. Kossakovski, South Pasadena, CA (US); Jesse L. Beauchamp, La Canada Flintridge, CA (US); Monika E. Freiser, Miami, FL (US)

(73) Assignee: CALIFORNIA INSTITUTE OF TECHNOLOGY, Pasadena, CA (US)

(21) Appl. No.: 14/578,897

(22) Filed: Dec. 22, 2014

Related U.S. Application Data
(63) Continuation of application No. 13/625,025, filed on Sep. 24, 2012, now abandoned.
(60) Provisional application No. 61/537,965, filed on Sep. 22, 2011.

(51) Int. Cl. G01N 1/22; B05B 5/057; H01J 49/16; H01J 49/00; G01N 1/40

(52) U.S. Cl. CPC G01N 1/2273; H01J 49/0031; G01N 1/4022; H01J 49/165; B05B 5/057; G01N 2001/2282; G01N 2001/4033

(57) ABSTRACT

An atmospheric condensate collector and electrospray source apparatus. The apparatus has a cooler having a surface with a sharp point. The cooler generates a condensate from ambient atmosphere exposed to the cooler. A ground electrode is electrically and mechanically separated from the cooler. A high voltage power supply switchably provides a high voltage between the sharp point of the cooler and the ground electrode. A controller is electrically connected to the cooler power supply and the high voltage power supply. The controller controls the operation of the cooler power supply and the high voltage power supply. The atmospheric condensate collector and electrospray ionizer apparatus generates the condensate and generates particulate spray from the condensate in response to command signals issued from the controller. In some embodiments, an analyzer is provided to analyze particles of the spray to determine the chemical composition of the condensate.

### CROSS-REFERENCE TO RELATED APPLICATIONS

This application is a continuation of co-pending U.S. patent application Ser. No. 13/625,025 filed Sep. 24, 2012 and claims priority to and the benefit thereof, which in turn claims priority to and the benefit of co-pending U.S. provisional patent application Ser. No. 61/537,965 filed Sep. 22, 2011, each of which applications is incorporated herein by reference in its entirety.

### STATEMENT REGARDING FEDERALLY FUNDED RESEARCH OR DEVELOPMENT

This invention was made with government support under CHE0416381 awarded by the National Science Foundation. The government has certain rights in the invention.

### FIELD OF THE INVENTION

The invention relates to ion sources in general and particularly to an ion source that operates in ambient air.

### BACKGROUND OF THE INVENTION

In the last decade, the field of ambient mass spectrometry (ambient MS) has seen extensive innovation with the construction of many ionizing sources and techniques which require little to no sample preparation. The two most successful methods of ambient MS have been the laser-based methods, like ELDI (see for example Shiea, J.; Huang, M.; HSu, H.; Lee, C.; Yuan, C.; Beech, I.; Sunner, J. Rapid Commun. Mass Spectrom. 2005, 19, 3701-3704.), and jet-based methods, most notably DESI (see for example Takáts, Z.; Wiseman, J. M.; Gologan, B.; Cooks, R. G. Science. 2004, 306, 471-473.), both of which specialize in the creation of secondary ions or metastables off of a surface or an analyte affixed to a surface. Plasma-based ionizers, like DART (see for example Cody, R. B.; Laramée, J. A.; Durst, H. D. Anal. Chem. 2005, 77, 2297-2302.), have routinely been able to sample ambient air in vivo, truly without being confined to a surface. In addition, corona discharge, beta decay sources such as radioactive nickel or tritium, and in general any convenient source of ions can be used to effect chemical ionization of trace species in ambient air. Laser and jet-based methods are generally restricted to analyzing surfaces.

There is a need for a convenient way to generate condensate and to generate analyzable particles therefrom.

### SUMMARY OF THE INVENTION

According to one aspect, the invention features an atmospheric condensate collector and electrospray source apparatus. The apparatus comprises a cooler having a cooler power supply switchably connected thereto; a needle in thermal communication with the cooler; a ground electrode electrically and mechanically separated from the needle; a high voltage power supply configured to provide a high voltage between the needle and the ground electrode, the high voltage power supply switchably connected between the needle and the ground electrode; and a controller electrically connected to the high voltage power supply, the controller configured to control the operation of the high voltage power supply; the atmospheric condensate collector and electrospray source apparatus configured to generate a condensate from ambient atmosphere and to generate particulate spray from the condensate in response to a command signal issued from the controller.

In one embodiment, the particulate spray comprises at least one of an ion and a charged spray particle.

In one embodiment, the cooler is a Peltier cooler.

In another embodiment, the needle is configured to generate condensate from ambient atmosphere when cooled by the cooler to a temperature below a dew point of the ambient atmosphere.

In yet another embodiment, the controller is electrically connected to the cooler power supply and is configured to control the operation of the cooler power supply.

In still another embodiment, the controller comprises a general purpose programmable computer.

According to another aspect, the invention relates to an analyzer apparatus. The analyzer apparatus comprises an atmospheric condensate collector and electrospray source, comprising a cooler having a cooler power supply switchably connected thereto; a needle in thermal communication with the cooler, the needle configured to generate condensate from ambient atmosphere when cooled by the cooler to a temperature below a dew point of the ambient atmosphere; a ground electrode electrically and mechanically separated from the needle; a high voltage power supply configured to provide a high voltage between the needle and the ground electrode, the high voltage power supply switchably connected between the needle and the ground electrode; and a controller electrically connected to the high voltage power supply, the controller configured to control the operation of the high voltage power supply; the atmospheric condensate collector and electrospray source apparatus configured to generate the condensate and to generate particulate spray from the condensate in response to command signals issued from the controller; and an analyzer configured to receive at least one particle of the particulate spray and to provide as a result a signal indicative of a chemical composition of the at least one particle of the particulate spray.

In one embodiment, the cooler is a Peltier cooler.

In another embodiment, the needle is configured to generate condensate from ambient atmosphere when cooled by the cooler to a temperature below a dew point of the ambient atmosphere.

In yet another embodiment, the controller is electrically connected to the cooler power supply and is configured to control the operation of the cooler power supply.

In still another embodiment, the controller comprises a general purpose programmable computer.

According to another aspect, the invention relates to a method of generating particulate spray from an ambient atmosphere. The method comprises the steps of providing an atmospheric condensate collector and electrospray source apparatus, comprising a cooler having a cooler power supply switchably connected thereto; a needle in thermal communication with the cooler, the needle configured to generate condensate from ambient atmosphere when cooled by the cooler to a temperature below a dew point of the ambient atmosphere; a ground electrode electrically and mechanically separated from the needle; a high voltage power supply configured to provide a high voltage between the needle and the ground electrode, the high voltage power supply switchably connected between the needle and the ground electrode; and a controller electrically connected to the high voltage power supply, the controller configured to control the operation of the high voltage power supply; the atmospheric condensate collector and electrospray source apparatus configured to generate the condensate and to generate particulate spray from the condensate in response to command signals issued from the controller; operating the cooler to generate on the needle a condensate from ambient gas; and operating the high voltage power supply to generate a particulate spray of the condensate from the needle.

In one embodiment, the particulate spray comprises at least one of an ion and a charged spray particle.

In another embodiment, the cooler power supply operates continuously.

In another embodiment, the high voltage power supply operates during a controlled time period, and is inoperative at times outside the controlled time period.

In yet another embodiment, the method further comprises the step of analyzing at least one particle of the particulate spray in an analyzer apparatus to provide a result.

In still another embodiment, the method further comprises the step of performing at least one of recording the result, transmitting the result to a data handling system, or to displaying the result to a user.

The foregoing and other objects, aspects, features, and advantages of the invention will become more apparent from the following description and from the claims.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIG. 1A is an image of the entire atmospheric condensate collector and electrospray ionizer device.

FIG. 1B is a close up image of a portion of the device showing relationships among the Peltier cooling element, the needle, and the support struts made of an insulator that support the front grounded electrode.

FIG. 1C is a cross sectional schematic diagram of the device.

FIG. 2A, FIG. 2B and FIG. 2C illustrate the condensation process over time.

FIG. 3 is an image of a protrusion of condensed liquid extending from the end of the needle.

FIG. 4 is a graph showing the mass spectrum of the ambient laboratory air.

FIG. 5 is a graphical representation of the protonated phthalic anhydride ion.

FIG. 6 is a diagram showing total ion current as a function of the distance between the tip of the needle and the mass spectrometer inlet position.

FIG. 7A is a spectrum showing intensity vs. mass to charge ratio for a sample containing the molecule diethyl ether, which is detected as protonated diethyl ether in the mass spectrum.

FIG. 7B is a graphical representation of protonated diethyl ether.

FIG. 8A is a spectrum showing intensity vs. mass to charge ratio for a sample containing molecular acetic acid, which is detected as protonated acetic acid in the mass spectrum.

FIG. 8B is a graphical representation of protonated acetic acid.

FIG. 9A is a spectrum showing intensity vs. mass to charge ratio for a sample containing acetone, which is detected as protonated acetone in the mass spectrum.

FIG. 9B is a graphical representation of protonated acetone.

FIG. 10A is a spectrum showing intensity vs. mass to charge ratio for a sample containing l-arginine, which is detected as protonated l-arginine in the mass spectrum.

FIG. 10B is a graphical representation of protonated l-arginine.

FIG. 11 is a flow diagram that illustrates the steps in an analytical process using the atmospheric condensate collector and electrospray ionizer of the invention.

FIG. 12 is a schematic diagram that illustrates the components of an analyzer comprising the atmospheric condensate collector and electrospray ionizer of the invention.

### DETAILED DESCRIPTION

The new and rapidly developing field of ambient mass spectrometry promises to provide robust real-time environmental sampling. We have characterized the capabilities of a new ambient mass spectrometry ion source that is another promising step toward this goal. The device accumulates a thin film of ambient atmospheric condensate onto a needle cooled below ambient temperature. In our implementation, thermoelectric cooling is employed for this purpose. The important consideration is that the needle is being cooled to a sufficiently low temperature that condensate appears on the needle. When sufficient liquid has been gathered, a high DC potential difference is applied between the needle and a nearby grounded electrode. The condensate migrates to the tip of the needle, creating a Taylor cone and progeny droplets. These droplets are subsequently analyzed by spectrometric instrumentation. In one embodiment, ionic species formed by this process are sampled through the atmospheric pressure inlet of an ion trap mass spectrometer. Other methods, such as ion mobility spectroscopy, can also be employed for analysis. While the ion formation process is in many ways analogous to electrospray ionization, the present source differs in that it does not require a separate supply of working fluid, instead deriving the liquid medium from atmospheric condensate. The source can operate at low relative humidity. This process is continuous and can run indefinitely, constantly sampling trace constituents in ambient air in real-time. Tests have shown that this methodology can detect and identify volatile compounds in the parts per million range and nonvolatile organics using an amino acid delivered in an aerosol in the millimolar range as a test sample. This atmospheric condensate ion source has a wide range of applications, such as the detection and monitoring of trace organics in ambient air. These include, but are not limited to, noninvasive medical diagnostics such as the detection of disease biomarkers in exhaled breath and the sensitive detection of drugs, explosives and chemical and biological weapons, permitting long term CBW monitoring, in ambient air

This work examines an ion source that samples ambient air in real time and is reminiscent of traditional ESI (see for example Fenn, J. B.; Mann, M.; Meng, C. K.; Wong, S. F.; Whitehouse, C. M. Science. 1989, 246, 64-71.). The Air Condensate Collector and Electrospray Source (ACCESS) combines a thermoelectric Peltier element and DC high voltage setup to achieve something similar to the merging of nESI and PESI. Similar to nESI (see, for example Wilm, M.; Mann, M. Anal. Chem. 1996, 68, 1-8.), ACCESS has a progeny droplet flow rate in the nanoliter-per-minute range. Similar to PESI (see, for example Chen, L. C.; Yu, Z.; Nonami, H.; Hashimoto, Y.; Hiraoka, K. Environ. Control Biol. 2009, 47, 73-86.), ACCESS has a needle off of which electrospray progeny droplets are drawn using a high voltage DC potential difference. However, PESI is restricted to sampling wet surfaces and nESI requires extensive sample preparation, as described in Karas, M.; Bahr, U.; Dülcks. Fresenius J. Anal. Chem. 2000, 366, 669-676, while ACCESS requires no sample preparation and can sample ambient air. In one embodiment, the ACCESS ambient ion source uses condensed air to detect volatiles and nonvolatiles in air

ACCESS was constructed and subsequently modified to achieve ESI. The device's preliminary limits of detection were quantified for several volatile and nonvolatile compounds. Volatile compounds were detected in the ppb to low ppm range depending on the molecular species and l-arginine delivered in an aerosol into the ambient environment was detected at the micromolar range.

### The Device

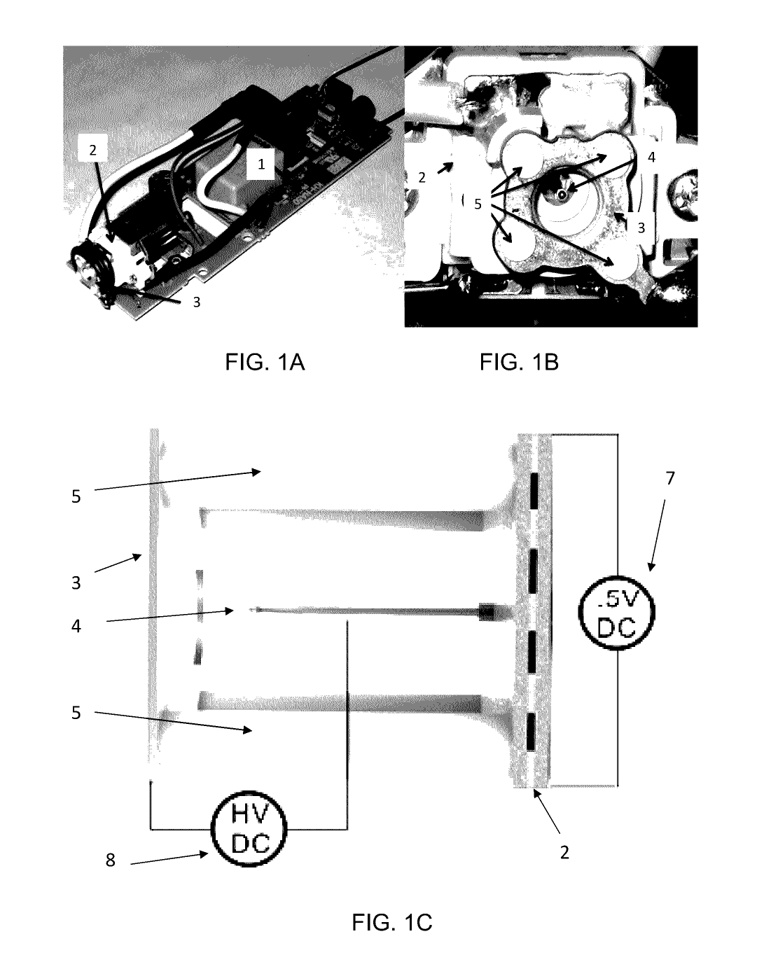

The first generation of the device used the Peltier-cooled ion source taken from a Panasonic AH-NA05 hairdryer (Matsushita Electric Industrial Co., Ltd., model EH5441). This device was purchased through EBay as it was not available in the United States at that time. The housing of the ion-generating portion was removed. The device's relevant components are explained as follows and are labeled in FIG. 1A, FIG. 1B, and FIG. 1C.

FIG. 1A is an image of the entire atmospheric condensate collector and electrospray ionizer device. The circuit board 1 powers a Peltier cooling element 2, which is hidden from view in this image. At the left of the image is the suspended grounded electrode 3.

FIG. 1B is a close up image of a portion of the device showing relationships among the Peltier cooling element 2, the needle 4, four struts 5 made of an insulator (such as plastic struts) that support the suspended grounded electrode 3.

FIG. 1C is a cross sectional schematic diagram showing the Peltier cooling element 2, the suspended grounded electrode 3, the needle 4, and the insulator struts 5, and in addition a low voltage power supply 7 that runs the Peltier cooler and a high voltage power supply 8. The low voltage power supply can be a 0.5V supply that runs the thermoelectric module, which cools off the protruding needle and causes condensation. In some embodiments, the low voltage power supply is a power supply that operates at a voltage of the order of 1 volt. The condensate is drawn to the tip of the needle with the high voltage potential difference, creating a Taylor cone and progeny droplets.

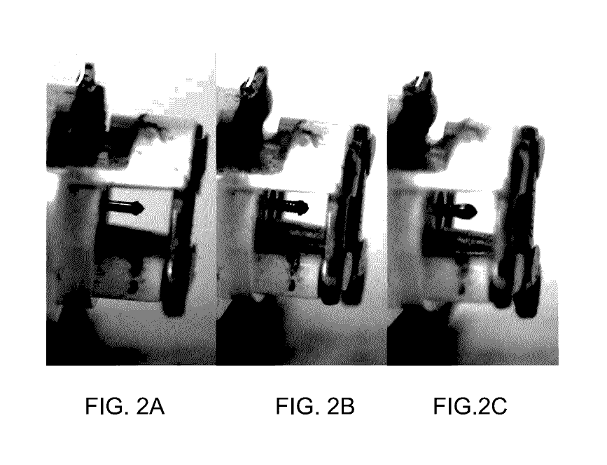

A thermoelectric Peltier element (hidden from view) draws 0.5V DC from the circuit board, subsequently cooling off a thermally and electrically conductive condensation needle that is connected to the cold side of the Peltier element. The condensation needle is attached and the Peltier element is housed in such a way that ambient air condenses primarily on the exposed surface of the needle. Four plastic struts support a circular metal electrode suspended 2 mm above the tip of the condensation needle. When the device was plugged into an AC wall socket with the AC cable provided with the purchase, the Peltier element was engaged and a 2 kV P—P 60 Hz AC potential difference was imposed on the condensation needle with regards to the suspended electrode, causing the accumulating condensate to undergo corona discharge ionization. This ionization method, however, did not provide the soft ESI-like sampling that was desired. Therefore, the ion-generating device was modified as follows: the lines connecting the circuit board to the condensation needle and the suspended electrode were severed and a high voltage DC generator was attached instead, with the condensation needle as biased with respect to the grounded suspended electrode. A 1 megaohm resistor was provided in this circuit to insure the current would not go above 15 microamps. The remaining electronics on the circuit board were left untouched. This second generation setup was used for the rest of the experimentation and is the ACCESS device. The AC cord from the circuitry was plugged in to deliver the 0.5V DC voltage to the Peltier element separate from the high voltage DC setup that was connected between the condensation needle and the suspended electrode (FIG. 2A, FIG. 2B and FIG. 2C).

FIG. 2A shows the source without the thermoelectric module cooling the needle. In FIG. 2B, the thermoelectric module has been cooling the needle for 30 seconds and water is starting to condense. FIG. 2C shows the device after 1 minute of running the thermoelectric cooler; the bulge of water is visible.

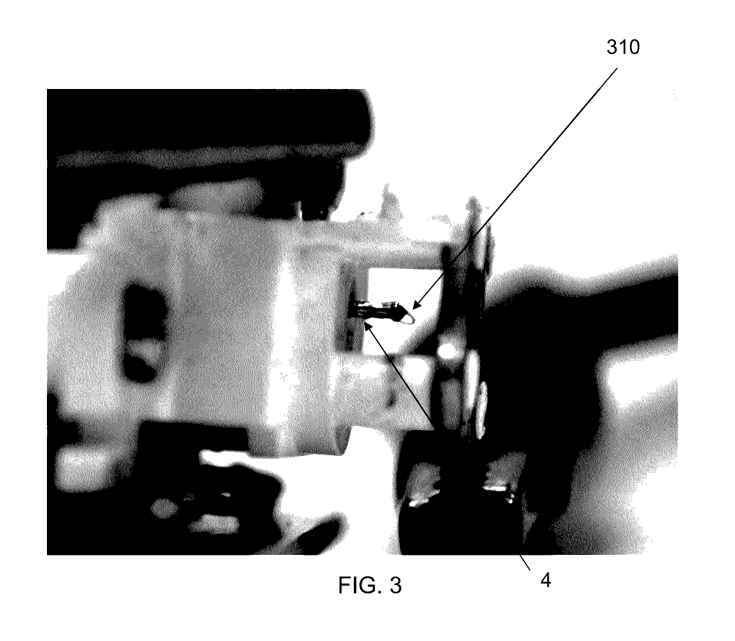

FIG. 3 is an image of a protrusion 310 of condensed liquid extending from the end of the needle. A high voltage potential is applied between the needle and the front electrode, causing the liquid film to slide off onto the tip of the needle and produce a Taylor cone.

In FIG. 3, the 0.5 V DC circuit that powered the Peltier cooler has been turned on, and the Peltier element and the condensation needle begin cooling down. Ambient air condensate accumulates on the outside of the needle. The accumulation rate of the condensate was determined to be 80 nL/min. After 1-2 minutes, a high voltage DC potential difference was applied between the condensation needle and the grounded suspended electrode using the DC high voltage power supply, starting with 2.5 kV and increased to 4.0 kV, when the desired results were reached. A voltage of 4.0 kV was used for the remaining demonstrations. The water film migrates to the tip of the condensation needle and closer to the suspended grounded electrode, producing progeny droplets ejected from an ESI-like cone (Taylor cone) off the tip of the needle.

These droplets are ejected toward the suspended grounded electrode, but are then intercepted by the mass spectrometer's vacuum inlet and are analyzed by the instrument. The device was oriented with the condensation needle pointing straight at the inlet (since tilting the source with respect to the mass spectrometer inlet lowered the signal strength) and only the distance between the front electrode and the inlet was changed.

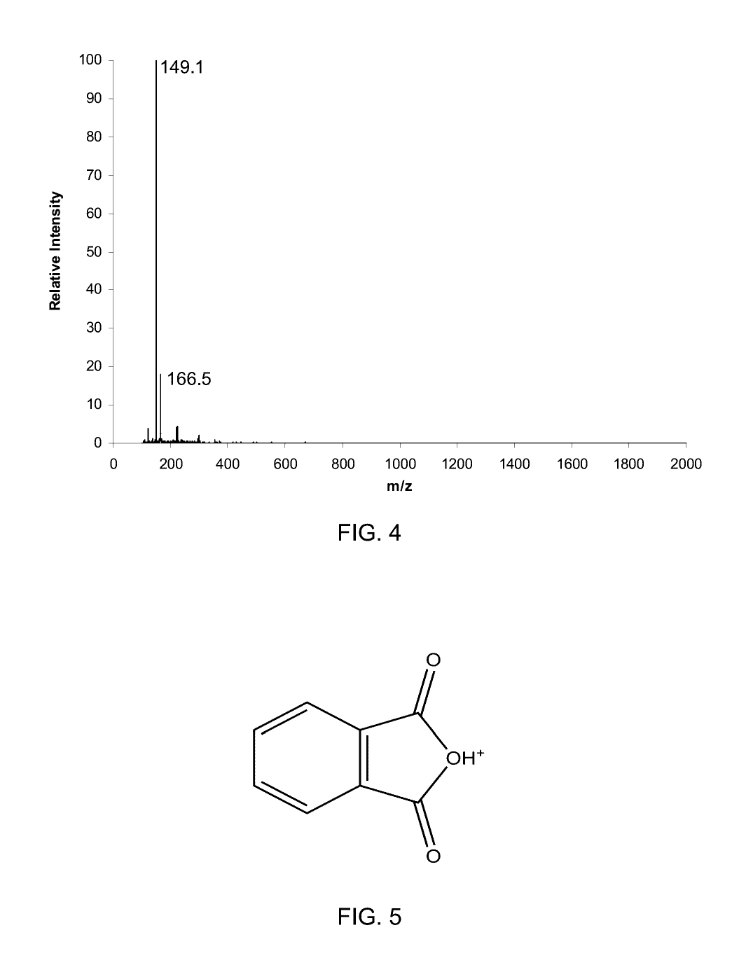

FIG. 4 is a graph showing the mass spectrum of the ambient laboratory air. The signal was strong and no sample preparation was required.

### Sample Preparation and Delivery

For standards runs of volatile compounds, microliter quantities of samples were injected into 37.7 liter 24×24 Cole-Palmer Kynar Gas Sampling Bags filled with compressed air, creating ppm and ppb levels of evaporated analyte in air. Acetone reacts with Kynar bags if the concentration is over 10%, so 3 mL of 10% acetone in water was injected into the bag and then agitated until all of the solution had evaporated. This gas bag method created a sample reservoir, which was hooked up to the input valve of a Custom Sensor Solutions, Inc. Model 1010 Precision Gas Diluter (available from Custom Sensor Solutions, Inc., 11786 N Dragoon Springs Drive, Oro Valley, Ariz. 85737 USA) with Tygon R-3603 Laboratory Tubing. More of the tubing was hooked up to the output valve and the diluted gas was passed over the front end of the ion source, approximately 5 mm from the needle tip. The flow rate exiting the diluter was measured to be ˜1.2 L/min. Each trial began by setting the input gas to 0% dilution concentration; i.e., only lab air from the diluent valve was flowing to the ACCESS. Then, the concentration of the introduced sample gas from the Kynar bag was raised slowly until a signal-to-noise ratio of at least 3:2 was achieved. The Kynar bags were flushed clean with compressed air between trials.

For nonvolatile aerosol runs, millimolar quantities of organics were prepared and poured into the reservoir of a commercial Sunbeam model 696 humidifier. At least 550 mL were needed to trip the switch for the humidifier to turn on, so 600 mL of millimolar solution was prepared. After the reservoir was filled with the solution, the humidifier was turned on and the aerosol flow was directed with a VWR thick glass Powder Funnel and VWR Vinyl Clear PVC Tubing to flow over the front end of the ion source. The distance from the front end of the ion source and the opening of the tubing was now 10-15 cm. This was done because at any closer distance, the aerosol flow was strong enough to blow away the ions generated off of the ACCESS needle before they could reach the mass spectrometer inlet. Aerosols if ejected too close to the device would also settle directly on the ion source's electronics and induce unwanted discharges.

### Instrumentation and Techniques

A Finnigan LCQ Deca Mass Spectrometer was used for the detection of ions. This instrument was modified only in the sense that the ESI mount blocking the inlet of the mass spectrometer was taken off completely and the safety interlocks overridden to function without the front ESI mount attached. The instrument was run in positive ion detection mode with otherwise default instrument settings. The term “limit of detection” is characterized as achieving roughly a 3:2 signal-to-noise ratio. Along with every spectrum is provided a rating of the relative intensity of the signal which should be taken as a comparative and relative measure between trials entirely for the reader's convenience. Experimentation was conducted in a climate controlled laboratory with a constant temperature of 70 degrees Fahrenheit and 50% humidity.

### Ambient Spectra

When the ion source was positioned near the mass spectrometer inlet, well defined spectra with strong signal were detected for both device generations. FIG. 4 shows the base ambient air spectrum for ACCESS. Collision induced dissociation was performed on the 149.1 peak, which fragmented like the common ESI contaminant protonated phthalic anhydride ion.

FIG. 5 is a graphical representation of the protonated phthalic anhydride ion.

### Detection as a Function of Distance

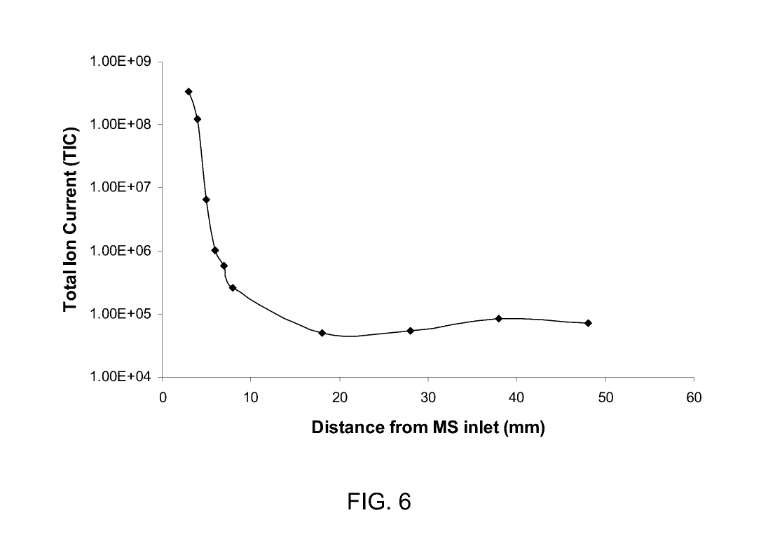

FIG. 6 is a diagram showing total ion current as a function of the distance between the tip of the needle and the mass spectrometer inlet position. The closest arrangement possible without further complications, 3 mm, was subsequently used to maximize the signal.

As the graph of FIG. 6 illustrates, the closer the ion source is to the mass spectrometer inlet, the stronger the signal, measured in total ion current (TIC). However, there are two limiting factors for how close the condensation needle can be positioned next to the inlet: the suspended electrode physically getting in the way and electrical discharge between the needle and the mass spectrometer's grounded inlet if the two are too close together. Positioning the needle at a distance of 3 mm from the mass spectrometer inlet provided maximum signal strength without the suspended electrode interfering or any discharge occurring.

### Volatile Trials and Limits of Detection

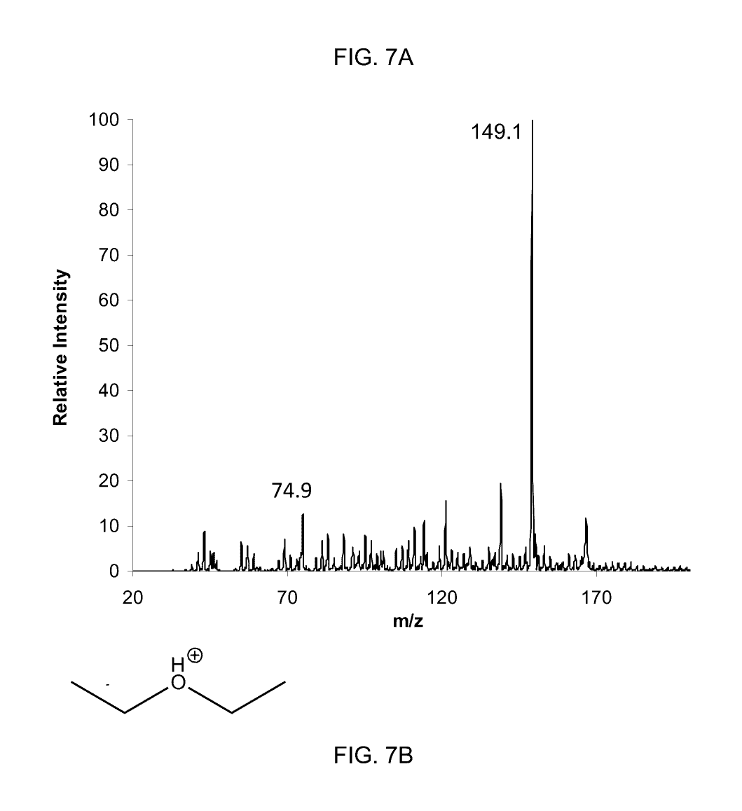

Standard runs of volatile compounds were performed as described in the Section Sample Preparation and Delivery (above). A 37.7 L Kynar bag of 9.5 ppm concentration of diethyl ether was prepared and run from 0% concentration up to 100%. FIG. 7A is a spectrum showing intensity vs. mass to charge ratio for a sample containing the molecule diethyl ether, which is detected as protonated diethyl ether in the mass spectrum. The most prevalent peak is still the plasticizer contaminant 149.1, but protonated diethyl ether is also detected at the m/z 74.9. The signal strength was 1.41e5.

FIG. 7B is a graphical representation of protonated diethyl ether.

As seen in FIG. 7A, the protonated molecule of diethyl ether at m/z of 74.9 was visible only at 100% diluent flow or 9.5 ppm. A bag of 14 ppm acetic acid was tested next, and the limit of detection was found to be at 20% diluent flow or 2.8 ppm acetic acid.

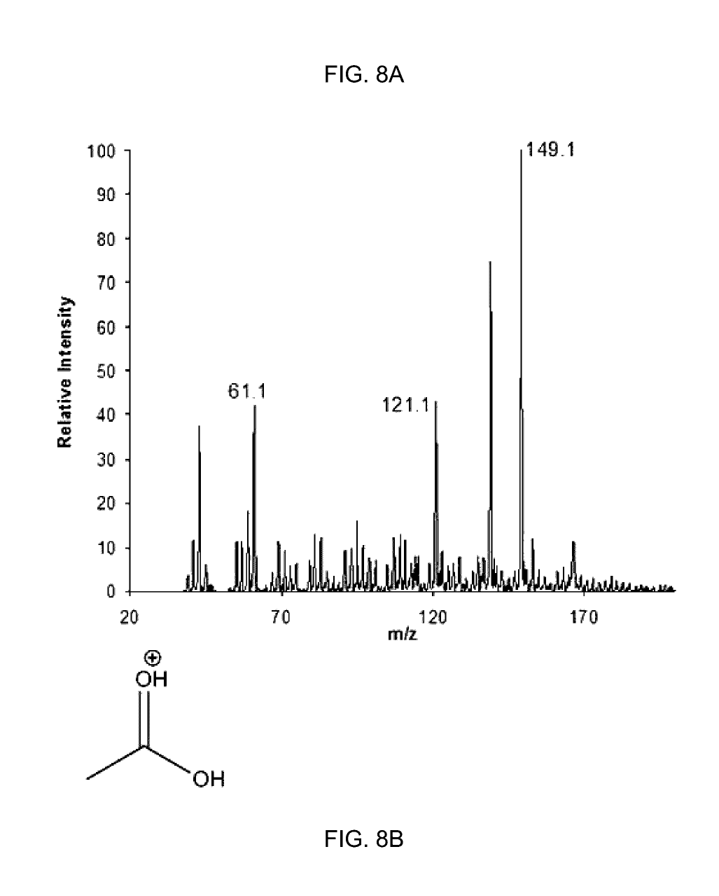

FIG. 8A is a spectrum showing intensity vs. mass to charge ratio for a sample containing molecular acetic acid, which is detected as protonated acetic acid in the mass spectrum. The signal strength was 1.46e5.

FIG. 8B is a graphical representation of protonated acetic acid.

Gaseous acetic acid was detected at 14 ppm as the protonated molecule at m/z 61.1 as shown in FIG. 8A.

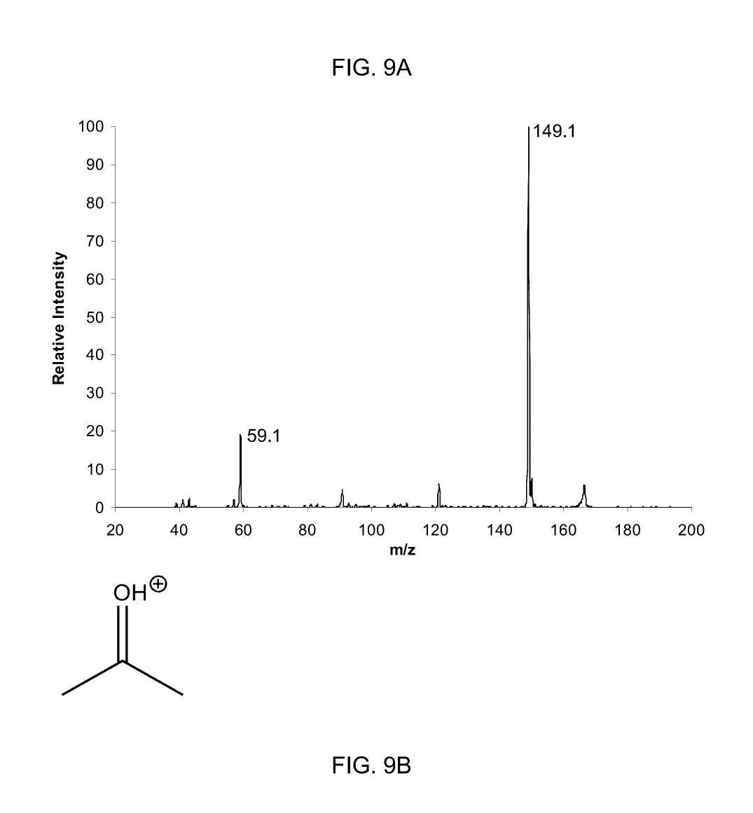

FIG. 9A is a spectrum showing intensity vs. mass to charge ratio for a sample containing acetone, which is detected as protonated acetone in the mass spectrum. The signal strength was 1.73e6.

FIG. 9B is a graphical representation of protonated acetone.

The same Kynar bag delivery method was used with 6.3 ppm acetone. FIG. 9A shows that the protonated molecule of acetone was detected at m/z 59.1 at 0.32 ppm. The signal to noise ratio in FIG. 9A is approximately 10:1. This gives a limit of detection of 0.03 ppm or 30 ppb.

### Detection of Nonvolatile L-Arginine in a Model Bioaerosol

Next, ACCESS's ability to detect nonvolatile molecules in an aerosol was tested. 600 mL of a 1.0 millimolar solution of l-arginine (molar mass 174.2 g/mol) in water was loaded into the humidifier as described in the Experimental section of this paper. The created aerosol was directed to the source via tubing, and the resulting stream of aerosol was billowed over the source. The flow of aerosol was quite strong and the aerosol stream interfered with the ion current, lowering the signal substantially.

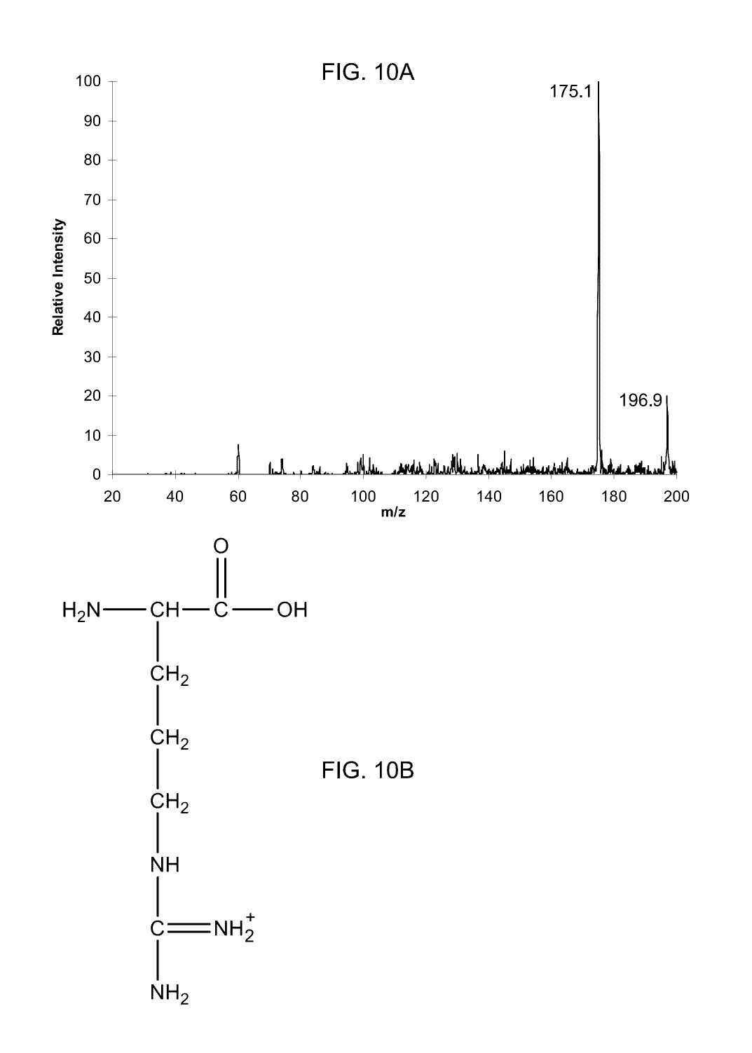

FIG. 10A is a spectrum showing intensity vs. mass to charge ratio for a sample containing l-arginine, which is detected as protonated l-arginine in the mass spectrum. The signal strength was low, at 2.84e3. It is believed that this was because the stream of aerosol was disrupting the flow of ions from the source to the mass spectrometer. As seen in FIG. 10A, l-arginine was detected as the protonated molecule at m/z 175.1 and as the sodium adduct at m/z 196.9.

FIG. 10B is a graphical representation of protonated l-arginine.

### Analytical Process

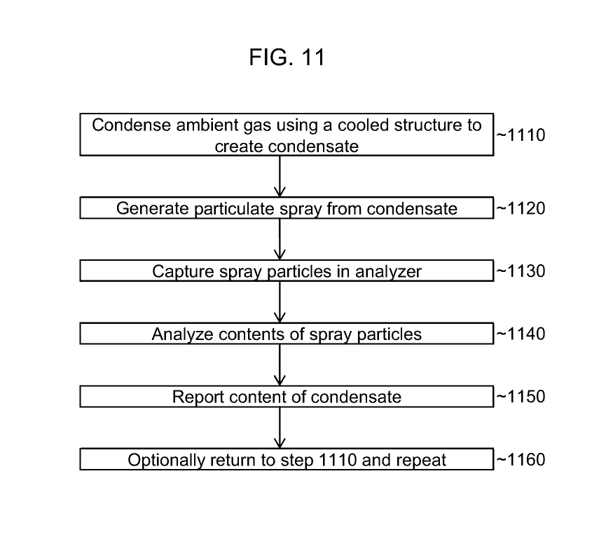

FIG. 11 is a flow diagram that illustrates the steps in an analytical process using the atmospheric condensate collector and electrospray ionizer of the invention. As shown in the flow chart of FIG. 11, in step 1110, one condenses ambient gas using a cooled structure to create a condensate. The cooled structure can be a Peltier cooler as previously described. The ambient gas can be any of room air (including any chemical species present therein), exhaled breath, or a gas sample taken in a location where it is believed or suspected that a substance of interest is present, with the expectation that one or more volatile species present in the ambient gas sample will permit determination of the presence or absence of the substance of interest, and possibly a concentration of such a substance. In a preferred embodiment, the condensation occurs in a device having a sharp tip.

In step 1120, a particulate spray is generated from the condensate, for example by application of a voltage between the sharp tip of the device in which the condensate is created and collected, the voltage being of sufficient magnitude to create a Taylor cone or similar structure with the ejection of particulate drops of the condensate. The applied voltage can be applied as a pulse, or as a time varying voltage.

In step 1130, the spray particles are captured in the analyzer. In one embodiment, the spray particles are entrained in a gas or fluid flowing into an input port of an analyzer. The entraining gas or fluid can be any one of ambient air, a gas selected to be inert or neutral as regards the analysis (such as nitrogen or argon gas) or another gas or fluid that is configured to entrain the spray particles and carry them into the analyzer. The analyzer can be a mass spectrometer, a laser-based analyzer or some other type of analyzer. Commercially available analysis machines can be used in this step and in the next step.

In step 1140, the contents of the spray particles are analyzed in the analyzer. This step contemplates the conventional operation of an analyzer, as is well known in the chemical and ion analysis arts.

In step 1150, the measured content of the condensate is reported, in any convenient form. The measured results can be reported in raw form for further analysis, or in a more sophisticated apparatus, for example one with access to a computer-readable medium on which reference analytical data are recorded, a report may include a determination of one or more chemical substances measured to be present in the analyzed spray particles.

In step 1160, one can optionally return to step 1110 and repeat steps 1110 through 1150 or 1160, as may be required or as may be desired.

In general, a general purpose programmable computer may be provided to control the actions of the ACCESS ion source and the analytical instrument, and to control the reporting, displaying and later transmission of the results of an analysis.

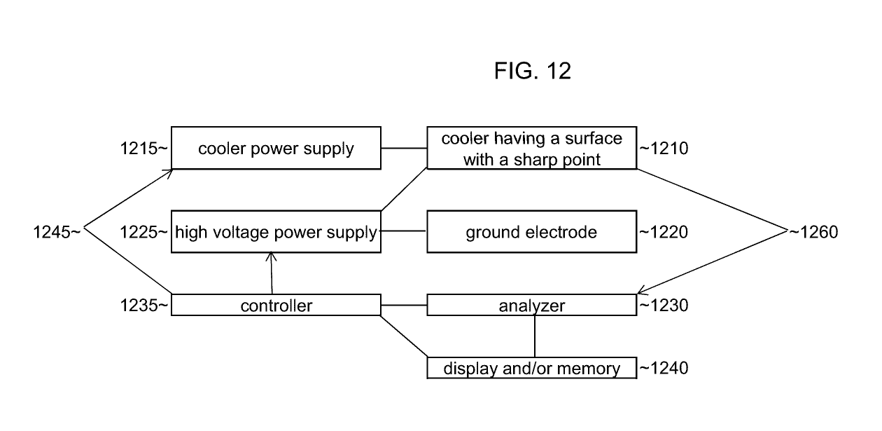

FIG. 12 is a schematic diagram that illustrates the components of an analyzer comprising the atmospheric condensate collector and electrospray ionizer of the invention. A cooler having a surface with a sharp point 1210 is provided. A cooler power supply 1215 is switchably connected to the cooler having a surface with a sharp point 1210. When the cooler is operated, a condensate is generated from ambient gas in contact with the cooler 1210. A ground electrode 1220 that is electrically and mechanically separated from the cooler having a surface with a sharp point 1210 is provided. A high voltage power supply 1225 is provided. The high voltage power supply 1225 is switchably connected between the cooler having a surface with a sharp point 1210 and the ground electrode 1220. A controller 1235, which in some embodiments is a control circuit based on a general purpose programmable computer, is connected to the cooler power supply 1215, and can issue control commands that that power supply as indicated by arrow 1245, and is connected to the high voltage power supply 1225, and can issue control commands to that power supply as indicated by the unlabeled arrow. Under appropriate conditions of operation of the cooler 1210, the controller 1235 can issue commands that cause a particulate spray indicated by arrow 1260 to be emitted from the cooler having a surface with a sharp point 1210. The particulate spray 1260 can be captured and analyzed by an analyzer 1230, and the result of the analysis can be displayed or stored on a display and/or storage device 1240. In some embodiments, the analyzer 1230 and the display and/or storage device 1240 are connected to the controller 1235, so that the controller 1235 can control how and when results of the analysis are displayed and stored.

In summary, a novel ion source, ACCESS, has been characterized and several test samples were detected. This real-time ambient air sampler can find volatile compounds in the ppm range and can also detect nonvolatile molecules delivered in aerosol form. One application for ACCESS in the laboratory is the real time sampling of gas phase chemistry. It is believed that this device can also be used as a robust, quick, and noninvasive medical diagnostics tool for sampling exhaled breath. For example, such analysis could be used for the detection of disease biomarkers or for the detection of volatile metabolites that are indicative of disease. In this field, the collection and analysis of exhaled breath condensate (EBC) has shown potential for being used as a diagnostic tool. See for example Mutlu, G. M.; Garey, K. W.; Robbins, R. A.; Danziger, L. H.; Rubinstein, I. Am. J. Respir. Crit. Care Med. 2001, 164, 731-737.

Other work is helping to link bio-aerosol markers found in breath to different diseases to potentially set up a database for disease identification. See for example Miekisch, W.; Schubert, J. K.; Noeldge-Schomburg, G. F. E. Clin. Chim. Acta. 2004, 347, 25-39; Shahid, S. K.; Kharitonov, S. A.; Wilson, N. M.; Bush, A.; Barnes, P. J. Am. J. Respir. Crit. Care Med. 2002, 165, 1290-1293; Tate, S.; MacGregor, G.; Davis, M.; Innes, J. A.; Greening, A. P. Thorax. 2002, 57, 926-929; and Hanazawa, T.; Kharitonov, S. A.; Barnes, P. J. Am. J. Respir. Crit. Care Med. 2000, 162, 1273-1276.

ACCESS is expected to provide a versatile, easy-to-use, noninvasive diagnostic instrument: A patient would only be asked to breath onto the instrument for a couple minutes while the breath condenses, ionizes, and is then analyzed.

ACCESS is expected to fare well in other fields where the application of mass spectrometry has traditionally blossomed, such as the detection of explosives and counterfeit drugs. See for example Fernandez, F. M.; Cody, R. B.; Green, M. D.; Hampton, C. Y.; McGready, R.; Sengaloundeth, S.; White, N. J.; Newton, P. N. ChemMedChem. 2006, 1, 702-705. The apparatus and methods are believed to be useful in such applications as detection of hazardous chemicals in the environment and the detection of chemical and biological weapons, including volatile organics and bioaerosols. Application of the device will also benefit from it having no necessary sample preparation and being able to conduct real-time, in situ analysis.

### DEFINITIONS

Unless otherwise explicitly recited herein, any reference to an electronic signal or an electromagnetic signal (or their equivalents) is to be understood as referring to a non-volatile electronic signal or a non-volatile electromagnetic signal.

Recording the results from an operation or data acquisition, such as for example, recording results at a particular frequency or wavelength, is understood to mean and is defined herein as writing output data in a non-transitory manner to a storage element, to a machine-readable storage medium, or to a storage device. Non-transitory machine-readable storage media that can be used in the invention include electronic, magnetic and/or optical storage media, such as magnetic floppy disks and hard disks; a DVD drive, a CD drive that in some embodiments can employ DVD disks, any of CD-ROM disks (i.e., read-only optical storage disks), CD-R disks (i.e., write-once, read-many optical storage disks), and CD-RW disks (i.e., rewriteable optical storage disks); and electronic storage media, such as RAM, ROM, EPROM, Compact Flash cards, PCMCIA cards, or alternatively SD or SDIO memory; and the electronic components (e.g., floppy disk drive, DVD drive, CD/CD-R/CD-RW drive, or Compact Flash/PCMCIA/SD adapter) that accommodate and read from and/or write to the storage media. Unless otherwise explicitly recited, any reference herein to “record” or “recording” is understood to refer to a non-transitory record or a non-transitory recording.

As is known to those of skill in the machine-readable storage media arts, new media and formats for data storage are continually being devised, and any convenient, commercially available storage medium and corresponding read/write device that may become available in the future is likely to be appropriate for use, especially if it provides any of a greater storage capacity, a higher access speed, a smaller size, and a lower cost per bit of stored information. Well known older machine-readable media are also available for use under certain conditions, such as punched paper tape or cards, magnetic recording on tape or wire, optical or magnetic reading of printed characters (e.g., OCR and magnetically encoded symbols) and machine-readable symbols such as one and two dimensional bar codes. Recording image data for later use (e.g., writing an image to memory or to digital memory) can be performed to enable the use of the recorded information as output, as data for display to a user, or as data to be made available for later use. Such digital memory elements or chips can be standalone memory devices, or can be incorporated within a device of interest. “Writing output data” or “writing an image to memory” is defined herein as including writing transformed data to registers within a microcomputer.

“Microcomputer” is defined herein as synonymous with microprocessor, microcontroller, and digital signal processor (“DSP”). It is understood that memory used by the microcomputer, including for example instructions for data processing coded as “firmware” can reside in memory physically inside of a microcomputer chip or in memory external to the microcomputer or in a combination of internal and external memory. Similarly, analog signals can be digitized by a standalone analog to digital converter (“ADC”) or one or more ADCs or multiplexed ADC channels can reside within a microcomputer package. It is also understood that field programmable array (“FPGA”) chips or application specific integrated circuits (“ASIC”) chips can perform microcomputer functions, either in hardware logic, software emulation of a microcomputer, or by a combination of the two. Apparatus having any of the inventive features described herein can operate entirely on one microcomputer or can include more than one microcomputer.

General purpose programmable computers useful for controlling instrumentation, recording signals and analyzing signals or data according to the present description can be any of a personal computer (PC), a microprocessor based computer, a portable computer, or other type of processing device. The general purpose programmable computer typically comprises a central processing unit, a storage or memory unit that can record and read information and programs using machine-readable storage media, a communication terminal such as a wired communication device or a wireless communication device, an output device such as a display terminal, and an input device such as a keyboard. The display terminal can be a touch screen display, in which case it can function as both a display device and an input device. Different and/or additional input devices can be present such as a pointing device, such as a mouse or a joystick, and different or additional output devices can be present such as an enunciator, for example a speaker, a second display, or a printer. The computer can run any one of a variety of operating systems, such as for example, any one of several versions of Windows, or of MacOS, or of UNIX, or of Linux. Computational results obtained in the operation of the general purpose computer can be stored for later use, and/or can be displayed to a user. At the very least, each microprocessor-based general purpose computer has registers that store the results of each computational step within the microprocessor, which results are then commonly stored in cache memory for later use, so that the result can be displayed, recorded to a non-volatile memory, or used in further data processing or analysis.

Many functions of electrical and electronic apparatus can be implemented in hardware (for example, hard-wired logic), in software (for example, logic encoded in a program operating on a general purpose processor), and in firmware (for example, logic encoded in a non-volatile memory that is invoked for operation on a processor as required). The present invention contemplates the substitution of one implementation of hardware, firmware and software for another implementation of the equivalent functionality using a different one of hardware, firmware and software. To the extent that an implementation can be represented mathematically by a transfer function, that is, a specified response is generated at an output terminal for a specific excitation applied to an input terminal of a “black box” exhibiting the transfer function, any implementation of the transfer function, including any combination of hardware, firmware and software implementations of portions or segments of the transfer function, is contemplated herein, so long as at least some of the implementation is performed in hardware.

### Theoretical Discussion

Although the theoretical description given herein is thought to be correct, the operation of the devices described and claimed herein does not depend upon the accuracy or validity of the theoretical description. That is, later theoretical developments that may explain the observed results on a basis different from the theory presented herein will not detract from the inventions described herein.

Any patent, patent application, or publication identified in the specification is hereby incorporated by reference herein in its entirety. Any material, or portion thereof, that is said to be incorporated by reference herein, but which conflicts with existing definitions, statements, or other disclosure material explicitly set forth herein is only incorporated to the extent that no conflict arises between that incorporated material and the present disclosure material. In the event of a conflict, the conflict is to be resolved in favor of the present disclosure as the preferred disclosure.

While the present invention has been particularly shown and described with reference to the preferred mode as illustrated in the drawing, it will be understood by one skilled in the art that various changes in detail may be affected therein without departing from the spirit and scope of the invention as defined by the claims.

1. An atmospheric condensate collector and electrospray source apparatus, comprising:
a cooler having a cooler power supply switchably connected thereto;
a needle in thermal communication with said cooler;
an electrode electrically and mechanically separated from said needle;
a voltage power supply configured to provide a voltage between said needle and said electrode, said voltage power supply switchably connected between said needle and said electrode;
a controller electrically connected to said voltage power supply, said controller configured to control the operation of said voltage power supply;
said atmospheric condensate collector and electrospray source apparatus configured to generate a condensate on the needle from ambient atmosphere comprising an analyte, when the needle is cooled by said cooler, and to generate particulate spray from said condensate on the needle, without providing a separate supply to the condensate, in response to a command signal issued from said controller; and
an analyzer configured to identify the analyte in the spray.

2. The atmospheric condensate collector and electrospray source apparatus of claim 1, wherein said particulate spray comprises at least one of an ion and a charged spray particle.

3. The atmospheric condensate collector and electrospray source apparatus of claim 1, wherein said cooler is a Peltier cooler.

4. The atmospheric condensate collector and electrospray source apparatus of claim 1, wherein said needle is configured to generate condensate from ambient atmosphere when cooled by said cooler to a temperature below a dew point of said ambient atmosphere.

5. The atmospheric condensate collector and electrospray source apparatus of claim 1, wherein said controller is electrically connected to said cooler power supply and is configured to control the operation of said cooler power supply.

6. The atmospheric condensate collector and electrospray source apparatus of claim 1, wherein said controller comprises a general purpose programmable computer.

7. An analyzer apparatus, comprising:
an atmospheric condensate collector and electrospray source, comprising:
a cooler having a cooler power supply switchably connected thereto;
a needle in thermal communication with said cooler, said needle configured to generate condensate from ambient atmosphere when cooled by said cooler, the ambient atmosphere comprising an analyte;
an electrode electrically and mechanically separated from said needle;
a voltage power supply configured to provide a voltage between said needle and said electrode, said voltage power supply switchably connected between said needle and said electrode; and
a controller electrically connected to said voltage power supply, said controller configured to control the operation of said voltage power supply;
said atmospheric condensate collector and electrospray source apparatus configured to generate said condensate comprising said analyte on the needle and to generate particulate spray comprising said analyte from said condensate on the needle in response to command signals issued from said controller; and
said particulate spray generated from said condensate without providing a separate supply to the condensate; and
an analyzer configured to receive at least one particle of said particulate spray and to provide, as a result, a signal indicative of a chemical composition of said analyte when said ambient atmosphere comprises a level of said analyte in a parts per million range.

8. The analyzer apparatus of claim 7, wherein said cooler is a Peltier cooler.

9. The analyzer apparatus of claim 7, wherein said needle is configured to generate the condensate from the ambient atmosphere when cooled by said cooler to a temperature below a dew point of said ambient atmosphere.

10. The analyzer apparatus of claim 7, wherein said controller is electrically connected to said cooler power supply and is configured to control the operation of said cooler power supply.

11. The analyzer apparatus of claim 7, wherein said controller comprises a general purpose programmable computer.

12. (canceled)

13. (canceled)

14. (canceled)

15. (canceled)

16. (canceled)

17. (canceled)

18. A method of analyzing an ambient atmosphere, comprising:
cooling a needle in an ambient atmosphere, wherein condensate from the ambient atmosphere condenses on the needle;
applying a voltage to the needle, wherein the condensate on the needle is ejected from said needle to form a particulate spray without providing a separate supply to the condensate; and
identifying an analyte in the particulate spray.

19. The method of claim 18, wherein the identifying can identify the analyte when the ambient atmosphere comprises a level of the analyte in a parts per million range.

20. The method of 18, wherein the ambient atmosphere comprises exhaled breath.

21. The method of claim 18, wherein the ambient atmosphere comprises a biological and/or chemical weapon.

22. The method of claim 18, wherein the analyte comprises a volatile compound.

23. The atmospheric condensate collector and electrospray source apparatus of claim 1, wherein said analyzer is configured to identify the analyte in said particulate spray when said ambient atmosphere comprises a level of said analyte in a parts per million range.

24. The atmospheric condensate collector and electrospray source apparatus of claim 1, wherein the ambient atmosphere comprises exhaled breath.

25. The atmospheric condensate collector and electrospray source apparatus of claim 1, wherein the ambient atmosphere comprises a biological and/or chemical weapon.

26. The atmospheric condensate collector and electrospray source apparatus of claim 1, wherein the analyte comprises a volatile compound.
